(19) United States
(12) Patent Application Publication
(10) Pub. No.: US 2009/0268470 A1
(43) Pub. Date: Oct. 29, 2009

(54) LED LAMP

(75) Inventors: Katsuyuki Okimura, Tokyo (JP); Tomoyuki Fukuda, Tokyo (JP)

Correspondence Address: YOUNG & THOMPSON, 209 Madison Street, Suite 500, ALEXANDRIA, VA, 22314, US

(73) Assignee: NEC LIGHTING, LTD., Tokyo (JP)

(21) Appl. No.: 12/093,227

(22) PCT Filed: Nov. 14, 2006
(86) PCT No.: PCT/JP2006/322663

§ 371 Date: May 9, 2008

(30) Foreign Application Priority Data
Nov. 14, 2005 (JP) 2005-328709
Sep. 25, 2006 (JP) 2005-258831

(51) Int. Cl. F21V 3/00

(52) U.S. Cl. 362/311.02

(57) ABSTRACT

A reduced size LED lamp includes: a cap of the type GX53 that meets IEC standards; a substrate attached to the cap, which an LED is mounted on; and a light emitting surface cover case attached to the cap so as to cover the substrate.

### TECHNICAL FIELD

The present invention relates to an LED lamp including a cap standardized by IEC.

### BACKGROUND ART

Today, electric lamps on the market include a bulb-type fluorescent lamp using a cap of the type GX 53 standardized by IEC (International Electrotechnical Commission), such as the product name “MICRO-LYNX F” manufactured by SYLVANIA. The cap of the type GX 53 that conforms to based on IEC standards has an advantage in having a slim structure with a thickness of approximately 20 mm. In order to make use of this advantage, its luminous tube is curved or joined so as to form a planar shape, thus realizing a reduction in the size of the above lamp.

As regards bulb-type lamps on the market, in addition to the lamps using a luminous tube, lamps using LED are known. The bulb-type LED lamp has semipermanent life and is used as a down light, mood lamp or the like.

In such a bulb-type LED lamp, there is used a cap (screw-type cap) of the same type as the candescent bulb (refer to Japanese Patent Laid-Open No. 2000-200512). For example, the product number “LED100VO.9WE12” manufactured by Toshiba Lights & Technology Corporation, using a cap of the type E12 of IEC standards, has a total lamp length of 41.5 mm.

The luminous tube of the above bulb-type fluorescent lamp that is on the market has a complex structure that enables a reduction in size. On the other hand, for the above bulb-type LED lamp on the market, manufacture of the luminous tube of the bulb-type fluorescent lamp does not required a complex process; but, due to the large length of the cap, the total length of the bulb-type LED lamp is large, which prevents a reduction in size. However, on the market, there is also a need for reducing the size of the LED lamp.

### DISCLOSURE OF THE INVENTION

To address the above circumstances, the object of the present invention is to provide a slim-type LED lamp similar to a slim-type bulb-type fluorescent lamp.

To achieve the above object, according to the present invention, there is provided an LED lamp that includes: a cap of the type GX53 that meets IEC standards; a circuit substrate incorporated into the cap, and an LED that is mounted thereon; and a cover case attached to the cap so as to cover the circuit substrate.

According to this structure, since the cap of the type GX53 that meets IEC standards is used, size reduction can be achieved while maintaining versatility. Further, since an LED is used, it is possible to assemble the lamp without carrying out a complex manufacturing process to achieve size reduction.

Also, in the above LED lamp, when a driver circuit to drive the LED is mounted on a surface of the circuit substrate opposite a surface that the LED is to be mounted, further downsizing is possible. Further, when the configuration to mount the LED is COB, further size reduction is possible.

Also, the above circuit substrate is preferably a metal core substrate.

As a result, heat generated by the LED can be efficiently transferred to the circuit substrate. In this case, a metal core may be exposed to a surface that the LED is to be mounted of the metal core substrate, and the LED may be directly die-bonded to the metal core. Alternatively, a metal core may be exposed to a surface that the LED is to be mounted of the metal core substrate, and a sub mount that the LED is mounted on may be secured to the metal core.

Further, when a metal block is further mounted on the driver circuit mounting surface of the circuit substrate, the thermal capacity of the circuit substrate is increased. Consequently, the junction temperature of the LED, when the LED is being used, decreases.

In this way, when a metal core substrate or metal block is used, the performance of radiating heat generated by the LED is raised, so that the long-life slim-type LED lamp is provided.

As described above, according to the present invention, slimming-down of the LED lamp can be achieved.

### BRIEF DESCRIPTION OF THE DRAWINGS

FIG. 1A is a top view of an LED lamp according to an exemplary embodiment of the present invention;

FIG. 1B is a side view of the LED lamp according to the exemplary embodiment of the present invention;

FIG. 1C is a bottom view of the LED lamp according to the exemplary embodiment of the present invention;

FIG. 2 is an exploded view illustrating components constituting the LED lamp according to the exemplary embodiment of the present invention;

FIG. 3 is an exploded view illustrating a preferred exemplary configuration of the LED lamp according to the present invention;

FIG. 4 is a view for explaining a preferred exemplary LED mounting configuration in the LED lamp according to the present invention; and

FIG. 5 is a view for explaining a preferred exemplary LED mounting configuration in the LED lamp according to the present invention.

### BEST MODE FOR CARRYING OUT THE INVENTION

An exemplary embodiment of the present invention will be described with reference to the drawings.

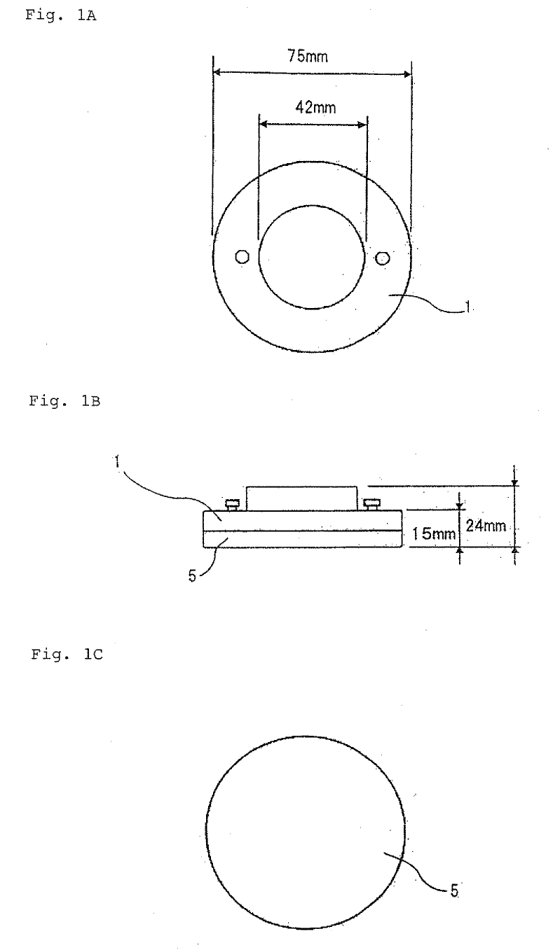

FIG. 1A illustrates a top view of an LED lamp according to an exemplary embodiment of the present invention; FIG. 1B illustrates a side view thereof;

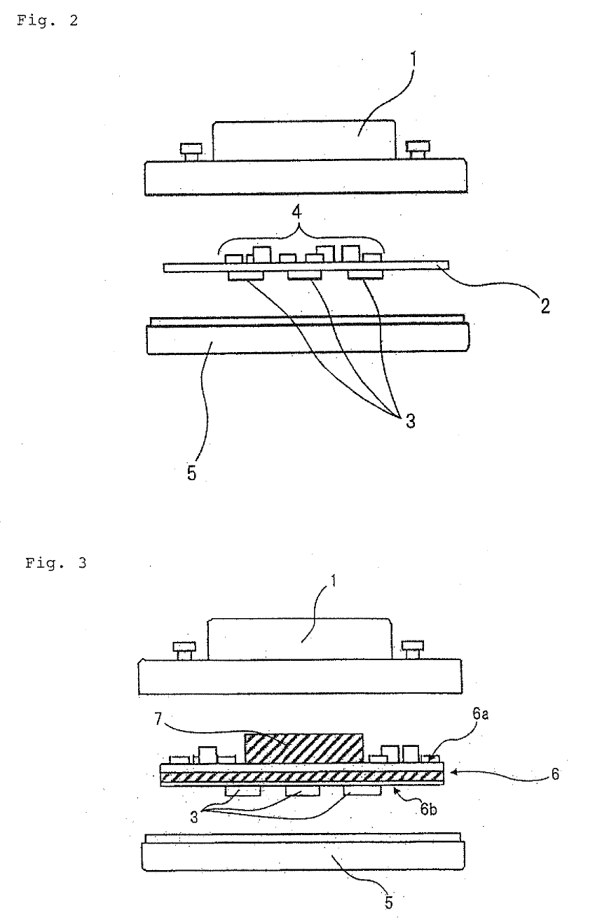

FIG. 1C illustrates a bottom view thereof. FIG. 2 is an exploded view illustrating components constituting the LED lamp illustrated in FIGS. 1A to IC.

The LED lamp having the configuration illustrated in FIGS. 1A to 1C and FIG. 2 uses cap 1 of the type GX53 that meets IEC standards. The cap of GX53 type has also been standardized by JIS (Japanese Industrial Standards) (JIS C 7709). In the housing of cap 1, there is incorporated circuit substrate 2; and a plurality of LED 3 are mounted on a surface of circuit substrate 2 opposite the cap 1 side surface. On the cap 1 side surface of circuit substrate 2, there is mounted driver circuit 4 that drives LED 3. Light-emitting surface cover case 5 is attached to cap 1 so as to cover circuit substrate 2 having LED 3 and driver circuit 4 mounted respectively on both surfaces thereof.

As a wiring material of circuit substrate 2 on which LED 3 is mounted, copper or aluminum having a low thermal resistance is used. For LED 3, a single color such as white, red, blue or green, or any combination of red, blue and green is used. With regard to the configuration to mount LED 3, a surface mount type LED (SMD) packaged with ceramic or molding resin may be mounted on the substrate; but, in order to further downsize the lamp, it is preferable to use COB (chip on board) by which an LED bear chip (a die) is directly mounted on the substrate. Of course, a FC (flip chip) mount may also be used.

For light-emitting surface cover case 5, a transparent or milky white material is used, or a prism-processed material is used, so that light can be extracted according to applications.

In the LED lamp having the above described configuration, since the cap of the type GX53 that meets IEC standards is used, downsizing can be achieved while maintaining versatility. For example, while a conventional LED lamp using a cap of the type E12 that meets IEC standards has a total length of 41.5 mm, the height (thickness) of the LED lamp according to the present invention is approximately 24 mm as illustrated in FIG. 1B.

Further, since an LED is used, a complex manufacturing process to achieve downsizing is not required as in a luminous tube of a bulb-type fluorescent lamp.

Further, since LED 3 and LED driver circuit 4 are directly mounted on circuit substrate 2, miniaturization can be achieved. In particular, when the configuration to mount LED 3 is COB, size reduction of the lamp can be achieved.

Preferably, the slim type LED lamp according to the present invention has the below described configuration to maximize its life.

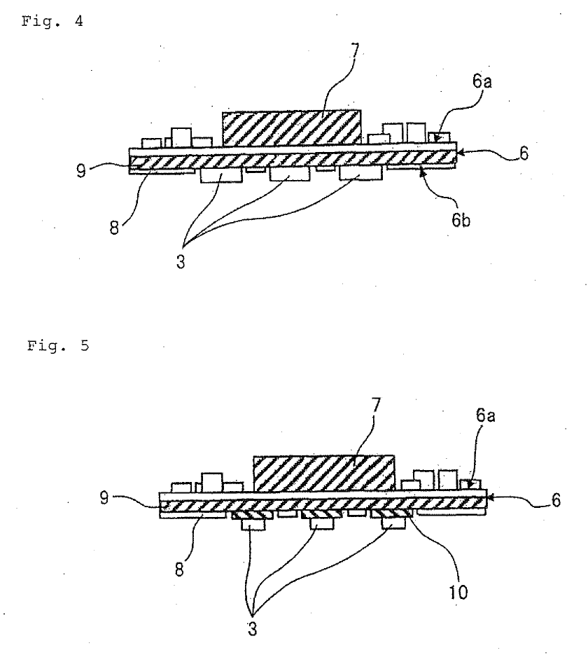

FIG. 3 illustrates a preferred exemplary configuration. As evident from FIG. 3, metal-core substrate (a printed substrate with a metal core) 6 is used, as the substrate on which bear chip LED 3 and the driver circuit are mounted. As a result, heat generated by LED 3 can be efficiently transferred to the LED 3 mounting substrate side.

Further, metal block 7 (for example, aluminum block) having high thermal conductivity is mounted on driver circuit mounting surface 6a of metal core substrate 6. The mounting is preferably performed by bonding using an adhesive that has high thermal conductivity (for example, radiation silicon adhesive), or by soldering. When metal block 7 is mounted in this way, the thermal capacity of the assembly in which LED 3 is mounted increases, and thus the junction temperature of LED 3 can be lowered.

As described above, when metal core substrate 6 and/or metal block 7 are used, thermal radiation performance increases, thus allowing prolonging the life of lamp.

Also, in mounting bear chip LED 3 on metal core substrate 6, when the configuration illustrated in FIGS. 4 and 5 is used, thermal radiation performance can be further increased. More specifically, as illustrated in FIG. 4, a window is arranged in insulation section 8 of surface 6b on which LED 3 is to be mounted of metal core substrate 6, so that metal core 9 is exposed. And bear chip LED 3 is directly mounted on this exposed metal core 9, so that heat generated by LED 3 can be efficiently transferred to metal core 9. In this case, the surface of the bear chip LED on which no electrode lies is preferably secured to metal core 9 by using an adhesive (for example, radiation silicon adhesive or AuSn paste) that has a high thermal conductivity, or by soldering.

Alternatively, as illustrated in FIG. 5, when sub mount 10 on which bear chip LED 3 has been mounted is secured to exposed metal core 9, heat generated by LED 3 can be efficiently transferred to metal core 9. In this case, when an insulating material (for example, AlN that has a high thermal conductivity) is used as the material of sub mount 10, mounting is possible even when electrodes lie on both the upper and lower surfaces. In securing sub mount 10, bonding by use of an adhesive that has a high thermal conductivity (for example, radiation silicon adhesive), or soldering is preferably applied.

1-7. (canceled)

8. An LED lamp comprising:
a cap of the type GX53 that meets IEC standards;
a circuit substrate incorporated into the cap, and having an LED mounted thereon; and
a cover case attached to the cap so as to cover the circuit substrate.

9. The LED lamp according to claim 8, further comprising a driver circuit to drive the LED and mounted on a surface of the circuit substrate opposite a surface on which the LED is to be mounted.

10. The LED lamp according to claim 8, further comprising a metal block mounted on a surface of the circuit substrate opposite a surface on which the LED is to be mounted.

11. The LED lamp according to claim 9, further comprising a metal block mounted on a surface of the circuit substrate opposite a surface that the LED is to be mounted.

12. The LED lamp according to claim 8, wherein the configuration to mount the LED is COB.

13. The LED lamp according to claim 8, wherein the circuit substrate is a metal core substrate.

14. The LED lamp according to claim 13, wherein a metal core is exposed to a surface on which the LED is to be mounted of the metal core substrate, and the LED is directly die-bonded to the metal core.

15. The LED lamp according to claim 13, wherein a metal core is exposed to a surface on which the LED is to be mounted of the metal core substrate, and a sub mount on which the LED is to be mounted is secured to the metal core.
